(19) United States
(12) Patent Application Publication
(10) Pub. No.: US 2015/0006241 A1
(43) Pub. Date: Jan. 1, 2015

(54) ANALYZING PARTICIPANTS OF A SOCIAL NETWORK

(71) Applicant: HEWLETT-PACKARD DEVELOPMENT COMPANY, L.P., HOUSTON, TX (US)

(72) Inventors: Zainab Jamal, Palo Alto, CA (US); Sitaram Asur, Palo Alto, CA (US)

(73) Assignee: HEWLETT-PACKARD DEVELOPMENT COMPANY, L.P., HOUSTON, TX (US)

(21) Appl. No.: 13/928,489

(22) Filed: Jun. 27, 2013

(51) Int. Cl. H04L 29/08; G06Q 30/02; G06Q 50/00; G06F 17/30

(52) U.S. Cl. CPC H04L 67/22; G06F 17/30867; G06Q 30/0201; G06Q 50/01
USPC 705/7.29; 709/204

(57) ABSTRACT

Analyzing plurality of participants of a computer-implemented social network. Data related to the plurality of participants is accessed. A query that includes a plurality of attributes associated with the plurality of participants is created. The plurality of attributes includes at least one social networking attribute and at least one business value attribute. The data related to the plurality of participants is evaluated based on the query and the plurality of attributes based on the data related to the plurality of participants is computed.

### BACKGROUND

Computer-implemented social networks have become very popular over the past years. These social networks generally include different numbers of participants that provide information to the social networks via their registration and use of the networks and the services offered by the networks. Further, web based communication technologies have also dramatically improved over the past years. An increasing number of users carry one or more mobile devices and can access the social networks from different locations, which allows them to continuously use the social networks and provide them with additional data. As the value and use of information continue to increase, companies look for improved ways to analyze, process, and store information related to the participants of these computer-implemented social networks and to the activities of these participants.

### BRIEF DESCRIPTION OF THE DRAWINGS

FIG. 1 is a schematic illustration of an example of a system for analyzing a plurality of participants of a computer-implemented social network.

FIG. 2 illustrates a schematic representation showing an example of a computing device of the system of FIG. 1.

FIG. 3 is a schematic illustration showing an example of a machine-readable storage medium encoded with instructions executable by a processor of the computing device of FIG. 2.

FIG. 4 illustrates a flow chart showing an example of a method for analyzing a plurality of participants of a computer-implemented social network.

FIG. 5 illustrates a graphical example of a social network and an example of a query including at least one social networking attribute and at least one business value attribute.

FIG. 6 illustrates a flow chart showing an example of a method for computing a business influence score for a participant of a computer-implemented social network.

FIG. 7 illustrates an example of a dynamic interactive graphical representation showing an analysis of a plurality of participants of a computer-implemented social network.

### DETAILED DESCRIPTION

As used herein, the terms computer-implemented social network and social network may be used interchangeably and refer to a system for social interaction between a plurality of social actors or participants (e.g., individuals or organizations). A social network provides tools for communication between its participants, defines complex links or connections between them, and provides ways for internal organization of these participants. Participants can connect to a social network via various web-based and mobile technologies and devices. Some examples of computer-implemented social networks include Facebook®, Snapfish®, Twitter®, LinkedIn®, and other similar social networks.

Some of these social networks can be very large (e.g., with hundreds of thousands or even millions of participants). These participants are linked (i.e., connected) to other participants of the social network, where some participants may be connected to a very large number of other participants (e.g., thousands). In many situations, the participants of these computer-implemented social networks actively communicate with each other (e.g., by sending messages, sharing files, links, or other information, etc.). A company may be also defined as a “social network” when social networking exists between the company's internal users (e.g., Snapfish® customers sharing pictures) but the company is not in the business of running a social network platform. These and other types of social interactions define the “social profile” of the network participants and generate social information related to the participants. Further; the participants can take advantage of various tools or programs offered by the social networks and can make purchases of products or services that are offered by the social networks or any of their partners (e.g., advertisers). In addition, some participants can influence other participants to make purchases by sharing links or other information directed to products and services. These type of business transactions and interactions define the “business profile” of the network participants and generate business value information related to the participants.

Analyzing the participants of the social networks and their activities is a high priority for the companies that operate these networks. A precise analysis of the participants, their connections, activities, behavior, influence, purchasing habits, etc. allows the companies to improve the quality of the services or products offered by the networks, to market the products they offer more successfully, and to increase the number of participants. Specifically, the companies want to “slice and dice” (i.e., analyze) their participants from different perspectives in order to understand what is their direct and indirect business value (e.g., in terms of direct profit from purchases and profit generated from sharing information to other participants) in the short term and in the long term. Further, the companies want to identify their key or important participants and be able to receive insights that will help them to communicate better and address issues more efficiently. With the changing standards in the marketing landscape of connected participants that share information and products, it is necessary for the companies operating the social networks to jointly evaluate the social profile of the participants as well as their business profile.

This description is directed to systems, methods, and machine-readable storage media to analyze a plurality of participants of a computer-implemented social network. Further the proposed systems, methods, and machine-readable storage media generate a dynamic interactive graphical representation for analyzing the plurality of participants of a computer-implemented social network. In one example, by using the techniques described below, different social information and business information related to the participants of a social network can be obtained, processed, and graphically represented. Every social network collects different information for its participants. The main body of collected information can be systematically analyzed, reduced, or organized into smaller parts or views to examine it from different viewpoints. The systematically organized and analyzed information can be then presented in a variety of different and useful visual ways.

In particular, the description proposes accessing data related to the plurality of participants of a computer-implemented social network and creating a query including a plurality of attributes associated with the plurality of participants, where the plurality of attributes include at least one social networking attribute and at least one business value attribute. Further, the description proposes evaluating the data related to the plurality of participants based on the query, computing the plurality of attributes based on the data related to the plurality of participants, and generating a visual output based on the query. The social networking attribute can include a business influence score for each participant that is computed based on a proportion of shares by a participant to influenced participants that converted to purchases by the influenced participants and based on the passivity score associated with each of the influenced participants.

The proposed systems, methods, and machine-readable storage media allow companies that operate the social networks to more precisely analyze the participants of the networks. Further, these companies can classify their participants into different groups (e.g., by level of importance) using both business value attributes and social networking attributes. This will allow the owners of the social networks to provide better services to the participants, to quickly address issues related to key participants, to offer products and services that will likely be used and purchased by the participants, and to ultimately increase the profits generated by the social networks.

As used herein, the term participant refers to an entity (e.g., a person or an organization) that is a member of a social network. Each participant is connected to other participants of the social networks and communicates or otherwise interacts with the other participants over one or more network connections. As used herein the terms owner of a social network or a company operating a social network may be used interchangeably and refer to an entity that controls and runs a social network. The owner of a social network provides (directly or indirectly) all necessary platforms and functionalities related to the operation of the social network. The owner of a social network also collects data related to the participants of the network.

Further, as used herein, the term social networking attribute refers to a metric related to the social activity (i.e., the social profile) of a participant in a social network. As explained in additional detail below, the company operating a social network evaluates the social value of each participant by analyzing the information related to the social networking behavior of the participant. To analyze this information, the companies use social networking attributes that allow the information to be transferred to a metric. Some of these social networking attributes include in-degree, out-degree, degree, business influence score, centrality, passivity score, similarity, etc.

As used herein, the term business value attribute refers to a metric related to the business activity (i.e., the business profile) of a participant in a social network. The participants in a social network can generate a business value (i.e., profit) to the owner of the social network by purchasing products or services from the social network or influencing other participants to make purchases by sharing information directed to products and services. To analyze the information related to the business activity of participants, the companies use business value attributes that allow the information to be transferred to a metric. Some of the business value attributes include gender, sharing date, purchase amount, frequency of purchase, time of purchase, account information, purchased product category, total amount spent, etc.

As used herein, the term automatically refers to acting or operating in a manner essentially independent of external human influence or control. A system or an element of a system may have the capability to start, operate, perform functions, etc., independently of specific requests or regulations.

In the following detailed description, reference is made to the accompanying drawings, which form a part hereof, and in which is shown by way of illustration specific examples in which the disclosed subject matter may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. It should also be noted that a plurality of hardware and software based devices, as well as a plurality of different structural components may be used to implement the disclosed methods and systems.

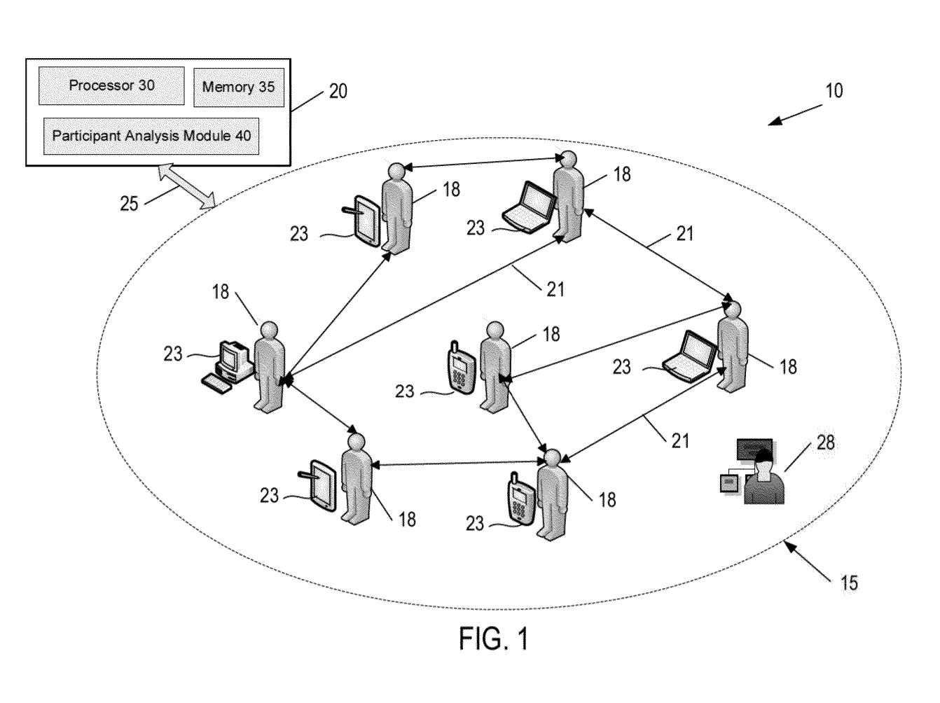

FIG. 1 is a schematic illustration of an example of a system 10 for analyzing a plurality of participants of a computer-implemented social network. The system 10 includes a social network 15, a computing device 20, and a network 25. In one example, the computing device 20 supports the social network 15 and is in communication with the social network 15 via the network 25. The computing device 20 can be external to the social network 15 or can be internal to the social network 15. In the illustrated example, the computing device 20 includes a processor 30, a memory 35, and a participant analysis module 40 to analyze the participants of the computer-implemented social network 15 by using social networking attributes and business value attributes associated with the participants.

The computer-implemented social network 15 illustrates an example of a social network 15 that connects a group of participants 18. The plurality of participants 18 are connected via links or connections 21. Each of the participants 18 uses at least one electronic device 23 (e.g., PC, laptop, tablet, smart phone, etc.) to communicate or otherwise interacts with the other participant 18, the social network 15, and the computing device 20. In one example the participants communicate with each other and with any external devices via the one or more network connections (e.g., the network 25 or other networks (not shown)). The social network 15 is operated and controlled by a company or an owner 28 that supports the social network 15 and provides the necessary hardware and software tools for running the network 15.

In some examples, the social network 15 can be a social network platform that includes multiple different social networks. The connections between the participants 18 may be single direction, such as where participant X (not shown) may view participant Y's communications, or bi-directional, such as where participant X may view participant Y's communications and participant Y (not shown) may view participant X's communications. Participants 18 may post or share communications, such as messages, links, photographs, videos, or other information, using an electronic device 23, and other participants 18 may view the communications on another electronic device 23. Participants 18 may receive communications directly from other participants or may be able to view communications posted by other participants. Participants 18 may communicate with one another on the social network 15, for example, using a network, such as the network 25, the Internet or another available network.

The network 25 connects the computing device 20 and the social network 15 so the social network 15 can transmit information to the computing device 20 and the computing device 20 can transmit information to the social network 15. In some examples, the social network 15 transmits information regarding the participants 18 and their actions. The network 25 may include any suitable type or configuration of network to allow the computing device 20 to communicate with the participants 18 and the social network 15.

For example, the network 25 may include a wide area network (“WAN”) (e.g., a TCP/IP based network, a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4GSM network, a Digital Enhanced Cordless Telecommunications (“DECT”) network, a Digital AMPS (“IS-136/TDMA”) network, or an Integrated Digital Enhanced Network (“iDEN”) network, etc.). The network 25 can further include a local area network (“LAN”), a neighborhood area network (“NAN”), a home area network (“HAN”), a personal area network (“PAN”), a public switched telephone network (“PSTN”), an Intranet, the Internet, or any other suitable network.

When a participant 18 registers with a social network 15 (i.e., when he or she creates an account), the participant 18 typically provides some type of information to the company 28. In one example, the participant 18 provides a name, email address, a location, etc. Alternatively, the participant can provide information about his or her age, gender, race, various preferences, and any other information. Using the computing device 20 (or another internal computing device), the social network 15 can create a user identification record (“ID”) associated with each participant 18 and store the information related to the participant in a database. Further, any other information that is generated by a participant 18 during his or her use of the social network 15 can also be associated with the participant's ID and stored in a database. For example, the social network 15 tracks social information related to each participant—the number of connections between a participant 18 and other participants in the network, the shares (e.g., links, messages, etc.) that a participant makes to other participants, the shares that a participant receives from other participants. In addition, the social network 15 tracks and stores various business value information related to the participants 18. For example, the social network 15 stores information about the services used or purchased by the participants, products purchased by the participants, and any sharing information related to any other attributes that generate value to the social network 15 (e.g., frequency of purchase, time of purchase, participant account information total amount spent, etc.).

The computing device 20 provides functionality for analyzing a plurality of participants 18 of the computer-implemented social network 15 based on the information about the participants 18 collected by the social network 15. It is to be understood that the operations performed by the computing device 20 that are related to this description can be performed by any other computing device associated with the social network 15. As described in additional detail below, in one example, the computing device 20 obtains information related to the plurality of participants of the computer-implemented social network 15 and receives an analytical request related to the plurality of participants, where the request includes at least one social networking attribute and at least one business value attribute associated with the plurality of participants. Further, the computing device 20 processes the information related to the plurality of participants based on the analytical request, determines at least one social networking attribute and at least one business value attribute associated with the plurality of participants, and creates a dynamic interactive graphical representation of the analytical request. The dynamic interactive graphical representation can include information about at least one social networking attribute and at least one business value attribute related to each participant shown in the dynamic interactive graphical representation.

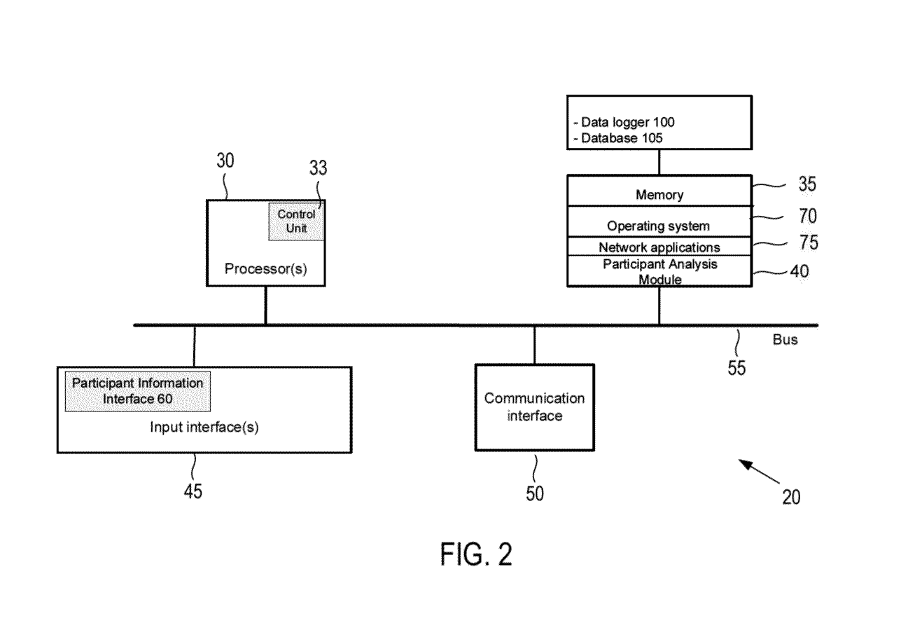

FIG. 2 shows a schematic representation of the computing device 20 of the system 10. The computing device 20 can be a server, a desktop computer, a laptop, or any other suitable device capable of carrying out the methods described below. The computing device 20 can be a device that is independent from the social network 15 or can be a devices included in the social network 15. The computing device 20 includes a processor 30 (e.g., a central processing unit, a microprocessor, a microcontroller, or another suitable programmable device), a memory 35, input interfaces 45, and a communication interface 50. Each of these components is operatively coupled to a bus 55. For example, the bus 55 can be an EISA, a PCI, a USB, a FireWire, a NuBus, or a PDS. In other examples, the computing device 20 includes additional, fewer, or different components for carrying out similar functionality described herein.

The communication interface 50 enables the computing device 20 and the system 10 to communicate with a plurality of networks. The input interfaces 45 can process information from the electronic devices 23 of the participants 18, other devices or systems in the social network 15, or another external device/system. In one example, the input interfaces 45 include at least a participant information interface 60. In other examples, the input interfaces 45 can include additional interfaces. The participant information interface 60 receives information about each participant 18. For example, the participant information interface 60 receives social network information regarding the social activities of the participants 18 (e.g., connections, shares, etc.) from the devices 23 of the participants 18, or another system/device of the social network 15. In addition, the participant information interface 60, receives business value information regarding the business activities of the participants (e.g. purchases, use of services, etc.). The interface 60 can include, for example, a connector interface, a storage device interface, or a local or wireless communication port which receives the information from the social network 15. In one example, the information regarding the social activities and the business activities from the social network 15 can be used to create or supplement databases stored in the memory 35.

The processor 30 includes a control unit 33 and may be implemented using any suitable type of processing system where at least one processor executes computer-readable instructions stored in the memory 35. The memory 35 includes any suitable type, number, and configuration of volatile or non-transitory machine-readable storage media to store instructions and data. Examples of machine-readable storage media in the memory 35 include read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, hard disk, an SD card, and other suitable magnetic, optical, physical, or electronic memory devices. The memory 35 may also be used for storing temporary variables or other intermediate information during execution of instructions to be executed by processor 30.

The memory 35 may also store an operating system 70, such as Mac OS, MS Windows, Unix, or Linux; network applications 75; and various modules (e.g., the participant analysis module 40). The operating system 70 can be multi-user, multiprocessing, multitasking, multithreading, and real-time. The operating system 70 can also perform basic tasks such as recognizing input from input devices, such as a keyboard, a keypad, or a mouse; sending output to a projector and a camera; keeping track of files and directories on memory 35; controlling peripheral devices, such as disk drives, printers, image capture device; and managing traffic on the bus 55. The network applications 75 include various components for establishing and maintaining network connections, such as computer-readable instructions for implementing communication protocols including TCP/IP, HTTP, Ethernet, USB, and FireWire.

The machine-readable storage media are considered to be an article of manufacture or part of an article of manufacture. An article of manufacture refers to a manufactured component. Software stored on the machine-readable storage media and executed by the processor 30 includes, for example, firmware, applications, program data, filters, rules, program modules, and other executable instructions. The control unit 33 retrieves from the machine-readable storage media and executes, among other things, instructions related to the control processes and methods described herein.

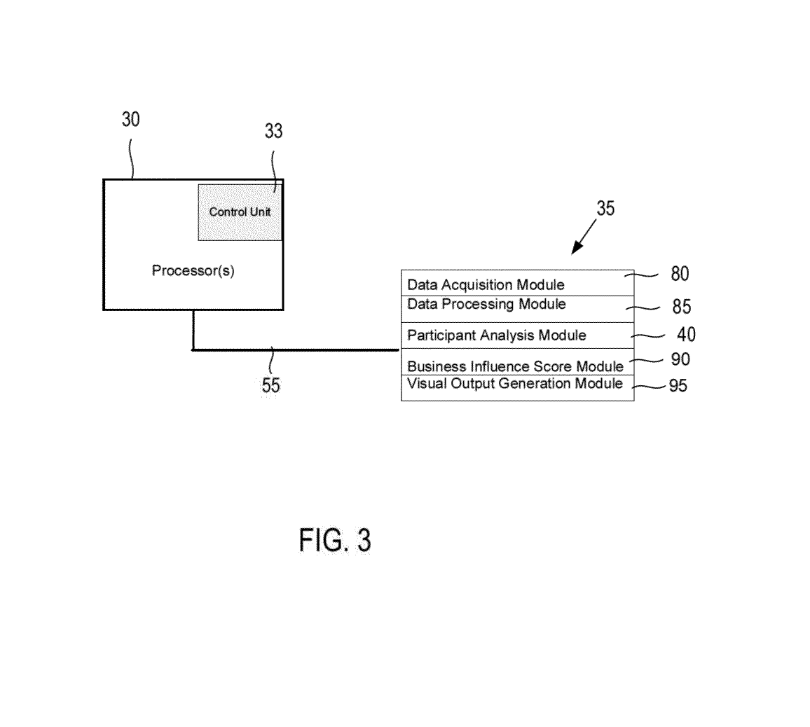

FIG. 3 illustrates an example of the machine-readable storage medium 35 encoded with instructions executable by the processor 30 of the system 10. In one example, the machine-readable storage medium 35 includes a data acquisition module (“DAQ”) 80, a data processing module 85, the participant analysis module 40, a business influence score generation module 90, and a visual output generation module 95. In other examples, the machine-readable storage medium can include more or fewer modules.

As explained in additional detail below, the participant analysis module 40 provides various computer-readable instruction components for analyzing a plurality of participants 18 of the computer-implemented social network 15 based data related to the plurality of participants. The business influence score generation module 90 provides various computer-readable instruction components for generating a business influence score for each participant based on a proportion of shares by a participant 18 to influenced participants that converted to purchases by the influenced participants and based on the passivity score associated with each of the influenced participants. The visual output generation module 95 provides various computer-readable instruction components for generating a dynamic interactive graphical representation for analyzing the plurality of participants 18 of the social network 15.

Information and data associated with the system 10, the social network 15, the participants 18 of the social network 15, and other systems/devices can be stored, logged, processed, and analyzed to implement the control methods and processes described herein. In addition to the data acquisition module 80, the memory 35 includes a data logger or recorder 100 and at least one database 105. The DAQ module 80 receives information or data from the social network 15, the participants 18, and from various external devices or systems. In one example, the DAQ module 80 continuously receives social network information and business value information regarding each participant 18 in the social network 15.

As noted above, the personal information received from each participant can include name, email and home address, age, gender, race, personal preferences, and any other information. Depending on the type of social network, the personal information can be considered social network information or business value information. The social network information can include the number of connections between the participant 18 and other participants in the network, the shares (e.g., pictures, music, apps, games, links, videos, reviews, etc.) from a participant to other participants, the shares that a participant receives from other participants. The business value information includes data regarding the participant (e.g., gender, etc.) and the participant's purchases via the social network.

The information gathered by the DAQ module 80 is provided to the data processing module 85 and the data logger or recorder 100. The data processing module 85 processes the information gathered by the DAQ module 80. The data logger or recorder 100 stores the information (e.g., social network information, business value information, etc.) in the database 105 for further storage and processing. In the database, the information received for each participant 18 can be correlated with the participant's user identification record for easier access and retrieval. In one example, the database 105 is included in the memory 35 of the computing device 20. In another example, the database 105 is a remote database (i.e., not located in the computer 20). In that example, the data logger or recorder 100 provides the information through a network (e.g., the network 25) to the database 105. Alternatively, the database 105 can be included in the components of the social network 15.

Therefore, the information and data stored in the database 105 can be accessed by the computing device 20 for processing. For example, by using the methods described below, the computing device 20 may analyze the participants 18 of the computer-implemented social network 15 by using their social network information and business value information. The control unit 33 retrieves from the machine-readable storage media and executes, among other things, instructions related to the control processes and methods described herein. When executed, the instructions cause the control unit 33 to access data related to the plurality of participants, to process the data related to the plurality of participants based on an analytical request that includes at least one social networking attribute and at least one business value attribute associated with the plurality of participants. Further, the instructions cause the control unit 33 to determine a plurality of attributes based on the data, where the attributes include at least one social networking attribute and at least one business value attribute. In addition, the instructions cause the control unit 33 to generate a dynamic interactive graphical representation of the analytical request, where the dynamic interactive graphical representation includes a business influence score for each participant.

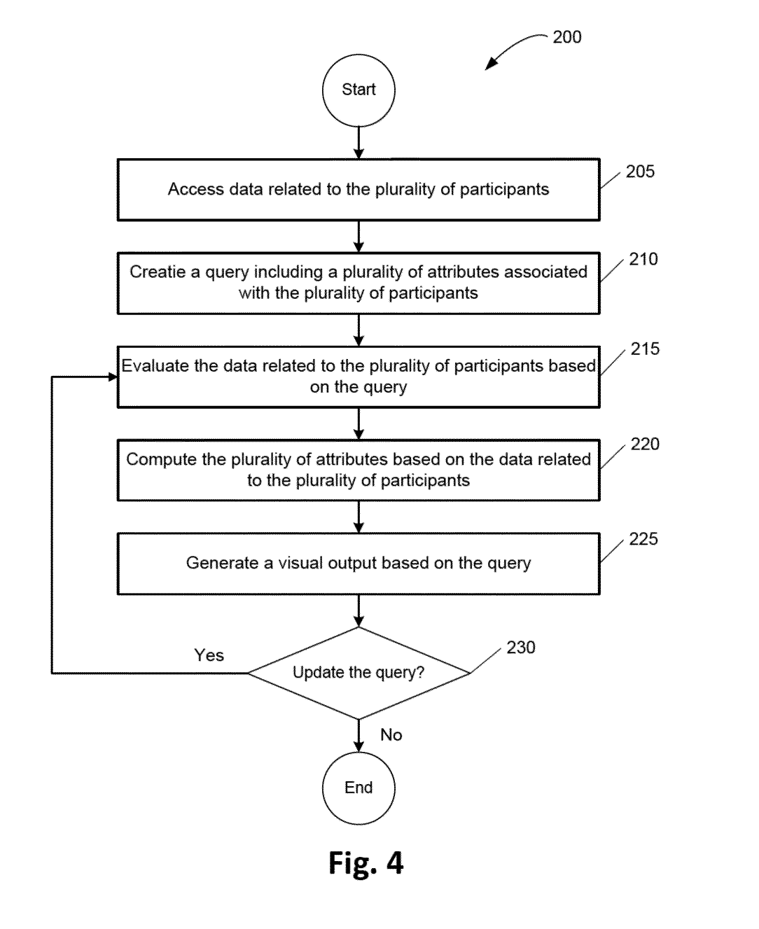

FIG. 4 illustrates a flow chart showing an example of a method 200 for analyzing a plurality of participants 18 of the computer-implemented social network 15. The method 200 can be executed by the control unit 33 of the processor 30. Various steps described herein with respect to the method 200 are capable of being executed simultaneously, in parallel, or in an order that differs from the illustrated serial manner of execution. The method 200 is also capable of being executed using additional or fewer steps than are shown in the illustrated examples.

The method 200 may be executed in the form of instructions encoded on a non-transitory machine-readable storage medium (e.g. medium 35) executable by the processor 30. In one example, the instructions for the method 200 are stored in the participant analysis module 40, the business influence score generation module 90, and the visual output generation module 95.

The method 200 begins in step 205, where the control unit 33 accesses data related to the plurality of participants 18. The data related to the plurality of participants 18 includes social network information and business value information. The control unit 33 can access the data related to the plurality of participants 18 when an owner 28 (e.g., a marketing manager) begins to perform an analysis of the participants 18 of the social network (i.e., when the owner 28 begins to operate a user interface to access the network 15). In some examples, the control unit 33 obtains information related to the plurality of participants that is stored in a database (e.g., the database 105 or another external database). Alternatively, the control unit 33 can access data that is uploaded to the social network 15 or extracted from another external system. Next, at step 210, the control unit 33 creates a query (also called a segment) that includes a plurality of attributes associated with the plurality of participants 18. For example, a user 28 of the social network (i.e., a company user or an owner user) generates a specific analytical request related to the plurality of participants of the network 15. The user 28 can enter the analytical request via a user interface (not shown). The analytical request includes at least one social networking attribute and at least one business value attribute. Based on the request, the control unit generates a query that simultaneously analyses the business value information and the social network information related to participants 18.

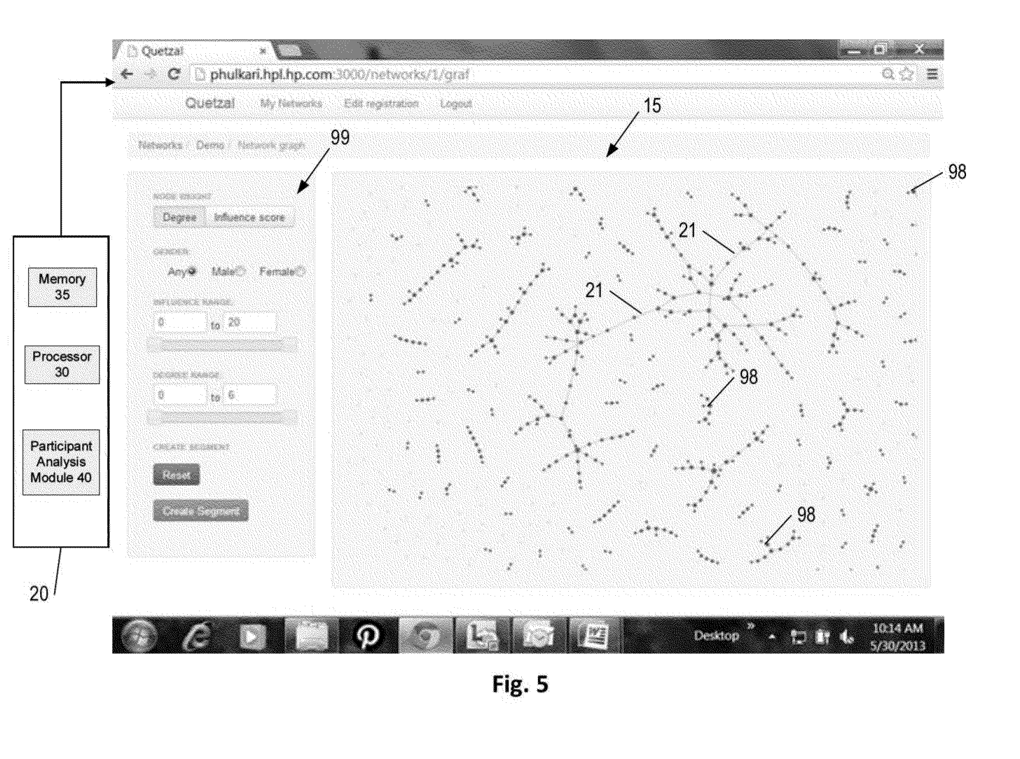

FIG. 5 illustrates a graphical example of a social network 15 (i.e., a plurality of nodes 98 and links 21) and an example of a query 99 including at least one social networking attribute and at least one business value attribute related to the participants of the network. The nodes 98 illustrate the participants 18 and the links 21 represent the connections between the participants 18 of the entire example social network 15. The query or analytical request 99 can include various social networking attributes and business value attributes for analyzing and classifying the participants of the network 15.

The social networking attributes can include: an in-degree—that represents the number of incoming connections that a participant 18 has (or the number shares sent to a participant 18 from other participants); an out-degree—that represents the number of outgoing connections that a participant 18 has (or the number of shares sent from a participant 18 to other participants); a degree—that represents the total number of connections that a participant 18 has (or the total number of shares sent to and from a participant 18); a business influence score—that represents the business influence of a participant 18, a centrality—that represents how reachable a participant is in a network (i.e., which participants are best connected to other users); a passivity score—that represents how unlikely participants are to purchase products based on shares from other participants (i.e., the participants level of failing to make purchases based on shared); and a similarity—that represents how similar two participants are in their purchasing behavior (i.e., whether they purchase similar items or they share other attributes in common). Other social networking attributes can also be defined by the social network. It is to be understood that depending on the type of social network 15, some social networking attributes can also be defined as business value attributes (e.g., passivity, similarity, etc.).

Further, the business value attributes can include: gender; sharing date—that represents the date(s) of the sharing between two participants; purchase amount—the amount of the product or service purchased by the participant; frequency of purchase—how many times has the participant purchased; time of purchase; participant account information; purchased product category; and total amount spent by a participant. Other business value attribute can also be defined by the social network. The query or analytical request 99 shown in FIG. 5 includes a degree range, an influence score range, and gender attributes. It is to be understood that the query or analytical request 99 shown in FIG. 5 illustrates an example and that users can create various queries that include different types of social networking attributes and business value attributes.

With continued reference to FIG. 4, in step 215, the control unit 33 evaluates or processes the data related to the plurality of participants based on the received query. For example, the control unit 33 uses the accessed data (e.g., social network information and business value information) to analyze the participants based on the specific analytical request by the user. Next, the control unit 33 computes the plurality of attributes based on the data related to the plurality of participants (at step 220). In one example, the control unit 33 determines at least one social networking attribute and at least one business value attribute associated with the plurality of participants. The social networking attributes and the business value attributes are determined based on the information related to the plurality of participants that is available to the control unit 33. By evaluating the available social network information and business value information related to each participant, the control unit 33 can compute exact values for the attributes as requested by the user.

For example, the control unit 33 computes the in-degree, the out-degree, and the degree attributes by using the social network information related to the participants 18. The control unit 33 accesses the data related to each participant stored in the database 105 to identify the incoming connection or shares to a participant 18 from other participant and the outgaining connections or shares from a participant 18 to other participants. Based on the information the control unit 33 computes the in-degree attribute, the out-degree attribute, and the total number of connections or shares sent to and from a participant to identify the degree attribute. In addition, the control unit 33 accesses the business value information for each participant to determine the business value attributes. For example, the control unit 33 evaluates all the purchases of a participant to calculate a total amount spent by a participant and the frequency of purchase. Other social networking attributes and business value attributes can be similarly calculated by using the accessed information for each participant.

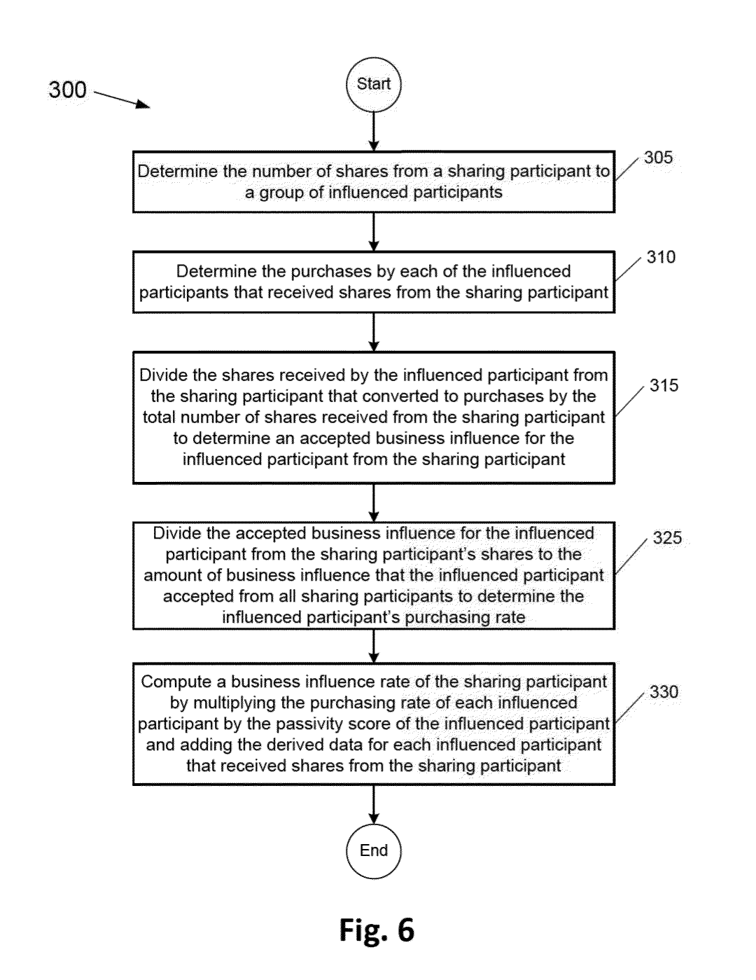

The method 200 is described in conjunction with FIG. 6 that illustrates a flow chart showing an example of a method 300 for computing a business influence score for a participant 18 of the computer-implemented social network 15. In one example, the business influence score for a participant 18 is computed based on a proportion of shares by a participant (also called a sharing participant) to a group of participants (also called influenced participants) that converted to purchases by the influenced participants and based on the passivity score associated with each of the influenced participants. In other examples, the business influence score can be computed by using other parameters and methods. The method 300 can be executed by the control unit 33 of the processor 30. Various steps described herein with respect to the method 200 are capable of being executed simultaneously, in parallel, or in an order that differs from the illustrated serial manner of execution. The method 300 is also capable of being executed using additional or fewer steps than are shown in the illustrated examples.

The method 300 may be executed in the form of instructions encoded on a non-transitory machine-readable storage medium (e.g., medium 35) executable by the processor 30. In one example, the instructions for the method 200 are stored in the business influence score module 90. The business influence score of a participant in a social network may be useful for marketing purposes. For example, the company or the owner of the social network 15 may determine which participants in the social network 15 have the highest business influence and should be targeted due to their ability to influence a large number of other participants.

The method 300 begins in step 305, where the control unit 33 determines the number of shares from a sharing participant 18 to a group of influenced participants of the network. For example, a sharing participant 18 shares 10 messages, files, etc. with participants X, Y, and Z (not shown). Next, the control unit 33 determines the purchases by each of the influenced participants that received shares from the sharing participant, where the purchases are based on the shares from the sharing participant (at step 310). For example, participant X may make three purchases based on the shares sent by the sharing participant 18, participant Y can make 5 purchases, and participant Z can make zero purchases.

Next, the control unit 33 computes the business influence score of the sharing participant based on the proportion of shares by the sharing participant to the influenced participants that converted to purchases by the influenced participants and based on the passivity level associated with each of the influenced participants. In one example, for each of the influenced participants, the control unit 33 divides the shares received by an influenced participant from the sharing participant that converted to purchases by the total number of shares received from the sharing participant to determine an accepted business influence for the influenced participant from the sharing participant (at step 315). Shares received from the sharing participants may include shares that the influenced participants had access to, such as shares specifically directed to these participants or shares posted by the sharing participant that may be viewed by influenced participants. In some examples, the shares may be considered to be received by the influenced participants whether or not the influenced participants actually viewed the shares.

Next, at step 325, the control unit 33 divides the accepted business influence for the influenced participant from the sharing participants shares (determined in step 315) to the amount of business influence that the influenced participant accepted from all sharing participants to determine the influenced participant's purchasing rate. The amount of business influence that the influenced participant accepted from all sharing participants is based on the shares received by the influenced participant from all sharing participant that converted to purchases divided by the total number of shares received from all sharing participants. At step 330, the control unit 33 computes the business influence rate of the sharing participant by multiplying the purchasing rate of each influenced participant by the passivity score of the influenced participant and adding the derived data for each influenced participant that received shares from the sharing participant. For example, if the sharing participant shared to influenced participants X, Y, and Z that have respective purchasing rates of (0.20), (0.54), and (0.68) and have respective passivity scores of (0.2), (0.8), and (0.9), the business influence score of the sharing participant may be determined by the following: (Participant X Purchasing Rate*Participant X Passivity Score)+(Participant Y Purchasing Rate*Participant Y Passivity Score)+(Participant Z Purchasing Rate*Participant Z Passivity Score)=(0.20*0.2)+(0.54*0.8)+(0.68*0.9)=1.138.

In one example, the passivity score for the participants is computed based on the level of failing to make purchases from the shares received by the sharing participant via the social network 15. Various calculations can be used to determine passivity score for the participants.

Referring back to FIG. 4, the control unit 33 continues with the process 200 in step 225 and can generate a visual output based on the query. In one example, the visual output includes a dynamic interactive graphical representation (i.e., a dynamic graph) that comprising nodes that represent a group of participants 18 and links 21 that represent connections between the participants. The graph includes information about at least one social networking attribute and at least one business value attribute for each participant included in the graph.

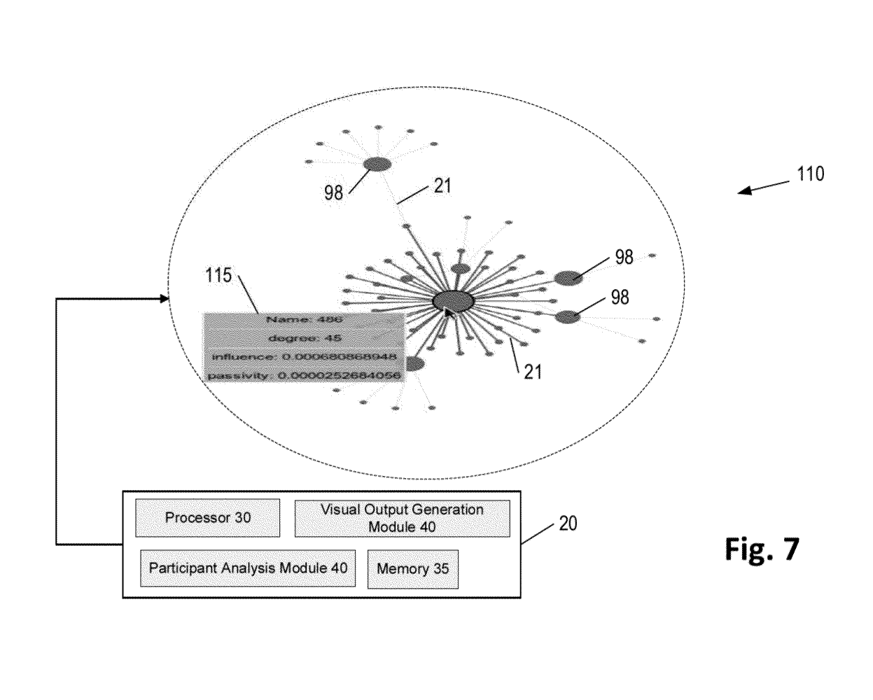

FIG. 7 illustrates one example of a dynamic interactive graphical representation 110 showing an analysis of the plurality of participants of the social network 15 generated by the control unit 33 based on a query. For example, the graphical representation 110 represents results based on a query similar to the query 99 illustrated in FIG. 5. It is to be understood that dynamic interactive graphical representation 110 is only an example and other types of graphical representations can be generated by the control unit 33 (e.g., pie charts, liner graphs, etc.). The graphical representation 110 includes nodes 98 that represent participants 18 and links 21 that represent the connections between the group of participants 18. Each node 98 of the graphical representation 110 includes least one social networking attribute and at least one business value attribute for each participant included in the graph. In one example, a user can view the social networking attributes and the business value associated with each node by viewing a participant information box 115 (i.e., by placing his or her cursor over a node 98). In the illustrated example, the participant information box 115 includes a name attribute, a degree attribute, a business influence score attribute, and a passivity attribute. In other examples, the participant information box 115 can include more or fewer attributes.

By using the described method for analyzing the plurality of participants of the social network 15 and generating a dynamic interactive graphical representation 110, the control unit 33 can identify key participants of the computer-implemented social network based on the at least one social networking attribute and at least one business value attribute. In one example, key participants are the participants that directly purchase products from the computer-implemented social network or directly influence other participants of the computer-implemented social network to purchase products. Participants that directly purchase products from the social network 15 can be identified by using business value attributes and participants that directly influence other participants of the network can be identified by using social network attributes. A query that includes a combination of social networking attributes and business value attributes allows for even better analysis of the participants 18 of the social network 15.

The generated dynamic graphical representation 110 can have different visual and operational characteristics. In one example, the edges 21 of the graphical representation 110 can have different colors that represent the direction of sharing between the participants 18 (e.g., red for sending a share and a green for receiving a share). Further, the nodes 98 of the graphical representation 110 can have different sizes based on the business influence score or another attribute associated with the participant 18 (e.g. participants 18 with larger business influence scores are represented by larger nodes). When the business graphical representation 110 shows a large number of participants, s user can also zoom on specific areas of the graphical representation 110.

At step 230, the control unit 33 determines if a user desires to update the exiting query. If the user does not make any updates to the query, the method 200 ends. In the alternative, if the user wants to update his or her analysis, the user can dynamically modify the query after the dynamic interactive graph 110 is generated to classify the plurality of participants based on at least one selected attribute. For example, if a user wants to further classify the participants show interactive graph by only showing participants 18 with a business influence scores higher than a specific threshold, the user cam dynamically modify the query while the graph is displayed. In that case, the control unit again performs steps 215, 220, and 225 as described above to generate an updated dynamic interactive graph 110.

What is claimed is:

1. A method for analyzing a plurality of participants of a computer-implemented social network, the method comprising:
accessing data related to the plurality of participants;
creating a query including a plurality of attributes associated with the plurality of participants, the plurality of attributes including at least one social networking attribute and at least one business value attribute;
evaluating the data related to the plurality of participants based on the query; and
computing the plurality of attributes based on the data related to the plurality of participants.

2. The method of claim 1, wherein the social networking attribute includes an in-degree, an out-degree, a degree, a business influence score, a centrality, a passivity score, and a similarity.

3. The method of claim 1, wherein the business value attribute includes a gender, a sharing date, a purchase amount, a frequency of purchase, a time of purchase, a participant account information, a purchased product category, and a total amount spent.

4. The method of claim 2, wherein the business influence score for a participant is computed based on a proportion of shares by a participant to influenced participants that converted to purchases by the influenced participants and based on the passivity score associated with each of the influenced participants.

5. The method of claim 1, further comprising generating a visual output based on the query, wherein the visual output includes a dynamic interactive graph comprising nodes that represent a group of participants and links that represent connections between the participants, and wherein the graph includes information about at least one social networking attribute and at least one business value attribute for each participant.

6. The method of claim 5, further comprising dynamically modifying the query after the dynamic interactive graph is generated to classify the plurality of participants based on at least one selected attribute.

7. The method of claim 1, further comprising identifying key participants of the computer-implemented social network based on the at least one social networking attribute and at least one business value attribute.

8. The method of claim 8, wherein the key participants directly purchase products from the computer-implemented social network or directly influence other participants of the computer-implemented social network to purchase products.

9. A system to generate a dynamic interactive graphical representation for analyzing a plurality of participants of a computer-implemented social network, the system comprising:
a computing device having a control unit to:
obtain information related to the plurality of participants of the computer-implemented social network;
receive an analytical request related to the plurality of participants, the request including at least one social networking attribute and at least one business value attribute associated with the plurality of participants;
process the information related to the plurality of participants based on the analytical request;
determine at least one social networking attribute and at least one business value attribute associated with the plurality of participants; and
create a dynamic interactive graphical representation of the analytical request, the dynamic interactive graphical representation including information about at least one social networking attribute and at least one business value attribute related to each participant shown in the dynamic interactive graphical representation.

10. The system of claim 9, wherein the social networking attribute includes at least an in-degree, an out-degree, a degree, a business influence score, a centrality, a passivity score, and a similarity.

11. The system of claim 10, wherein the control unit is to compute the business influence score for a participant by comparing a proportion of shares by a participant to a group of influenced participants that converted to purchases by the influenced participants with the passivity score associated with each of the influenced participants.

12. The system of claim 11, wherein the control unit is the compute the passivity score of the influenced participants based on the level of failing to make purchases based on shares received via the computer-implemented social network.

13. A non-transitory machine-readable storage medium encoded with instructions executable by a processor to analyze a plurality of participants of a computer-implemented social network, the machine-readable storage medium comprising instructions to:
access data related to the plurality of participants;
process the data related to the plurality of participants based on an analytical request that includes at least one social networking attribute and at least one business value attribute associated with the plurality of participants;
determine a plurality of attributes based on the data, the attributes including at least one social networking attribute and at least one business value attribute;
generate a dynamic interactive graphical representation of the analytical request, the dynamic interactive graphical representation including a business influence score for each participant that is computed based on a proportion of shares by a participant to influenced participants that converted to purchases by the influenced participants and based on the passivity score associated with each of the influenced participants.

14. The non-transitory machine-readable storage medium of claim 15, further comprising instructions to dynamically modify the analytical request after the dynamic interactive graphical representation is generated to classify the plurality of participants based on at least one selected attribute.

15. The non-transitory machine-readable storage medium of claim 16, further comprising instructions to identify key participants of the computer-implemented social network based on the at least one social networking attribute and at least one business value attribute, wherein the key participants directly purchase products from the computer-implemented social network or directly influence other participants of the computer-implemented social network to purchase products.
